(19) United States
(12) Patent Application Publication
(10) Pub. No.: US 2014/0206815 A1
(43) Pub. Date: Jul. 24, 2014

(54) Multiple-Component Variable Hardness Polyurethane System

(71) Applicant: Crosslink Technology, Inc., Mississauga (CA)

(72) Inventor: Dipak Parekh, Waterloo (CA)

(73) Assignee: Crosslink Technology, Inc., Mississauga (CA)

(21) Appl. No.: 14/167,675

(22) Filed: Jan. 29, 2014

Related U.S. Application Data
(63) Continuation of application No. 11/216,134, filed on Sep. 1, 2005, now abandoned.

(30) Foreign Application Priority Data
Sep. 2, 2004 (CA) 2480364

(51) Int. Cl. C08L 75/04

(52) U.S. Cl. CPC C08L 75/04
USPC 524/590

(57) ABSTRACT

A multi-component variable hardness polyurethane system and method of creating a thermosetting composition having a particular hardness. In the preferred embodiment a polyurethane compound can be created having any desired hardness between 10 and 90 Shore A, by mixing the same two curative components in different proportions, according to the hardness desired, along with a stoichiometrically determined amount of isocyanate as a hardener.

### CROSS REFERENCES

The present application claims priority benefit of U.S. application Ser. No. 11/216,134 entitled “ Multiple-Component Variable Hardness Polyurethane System” filed 1 Sep. 2005 which is incorporated herein by reference in its entirety.

### FIELD OF THE INVENTION

This invention relates to thermosetting compounds. In particular, this invention relates to a multiple-component thermosetting composition that uses the same basic components but the hardness of which can be varied over a wide range according to the proportion of the components used.

### BACKGROUND OF THE INVENTION

Thermosetting compounds are used in a variety of applications. One popular thermosetting compound, polyurethane, is used for example, on rollers for printers, photocopiers and the like, in which a polyurethane coating is applied over a steel mandrell. Polyurethane is also popularly used to fabricate components for manufacturing machinery, and in myriad other applications.

In many cases, manufacturers require thermosetting compounds having a wide range of different hardnesses. This requires that many of different compounds be maintained in inventory, which can be an organizational problem and can be quite confusing to workers who have to locate the compound of the desired hardness for a particular application. The application of thermosetting compounds of different hardnesses also often requires that manufacturing equipment be changed or adjusted to accommodate the different properties of a thermosetting compound having a different hardness.

It would accordingly be advantageous to provide a system and method which can create a thermosetting composition of a desired hardness within a wide range of hardnesses using a small number of components.

### SUMMARY OF THE INVENTION

The present invention provides a multi-component variable hardness polyurethane system. According to the invention a thermosetting composition, in particular polyurethane, can be created having any desired hardness between 10 and 90 Shore A, by mixing the same curative components in different proportions, according to the hardness desired, along with a stoichiometrically determined amount of isocyanate as a hardener.

In the preferred embodiment the composition of the invention can be created from three components: two curative components and an isocyanate. However, additional components may be used to create a composition within the scope of the invention.

### BRIEF DESCRIPTION OF THE DRAWINGS

In drawings which illustrate by way of example only a preferred embodiment of the invention,

FIG. 1 is a graph showing percentages of components for the production of a polyurethane of a defined hardness.

FIG. 2 is a chart showing mix ratios for the components in the preferred embodiment of the invention to create a composition having a hardness in a range from 10 Shore A to 90 Shore A.

### DETAILED DESCRIPTION OF THE INVENTION

In the preferred embodiment, the invention comprises a polyurethane compound having specific percentages of first and second curative components, and an isocyanate or hardening agent, for example methylene diphenyl isocyanate, added in a stoichiometrically determined amount. The preferred components are described herein by way of example for the preferred embodiment, however the invention is not intended to be limited to the specific components so described.

The first curative component is selected to have a very low hardness when mixed alone with the isocyanate, for example a composition containing glycol polyol, non reactive plasticizer, urethane catalyst, and a surfactant, in suitable proportions. The second curative component is selected to have a very high hardness when mixed alone with the isocyanate, for example a composition containing glycol polyol, liquid aromatic diamine, urethane catalyst, and a surfactant, in suitable proportions. The first and second components must be miscible, although, not necessarily upon first mixing.

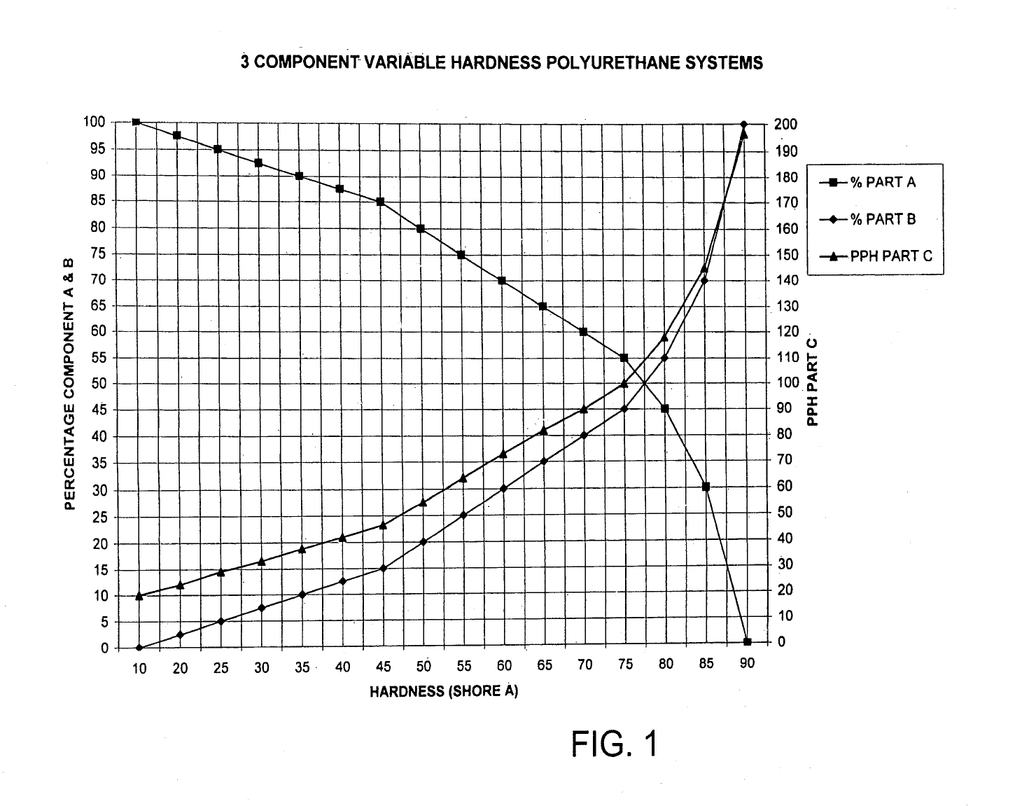

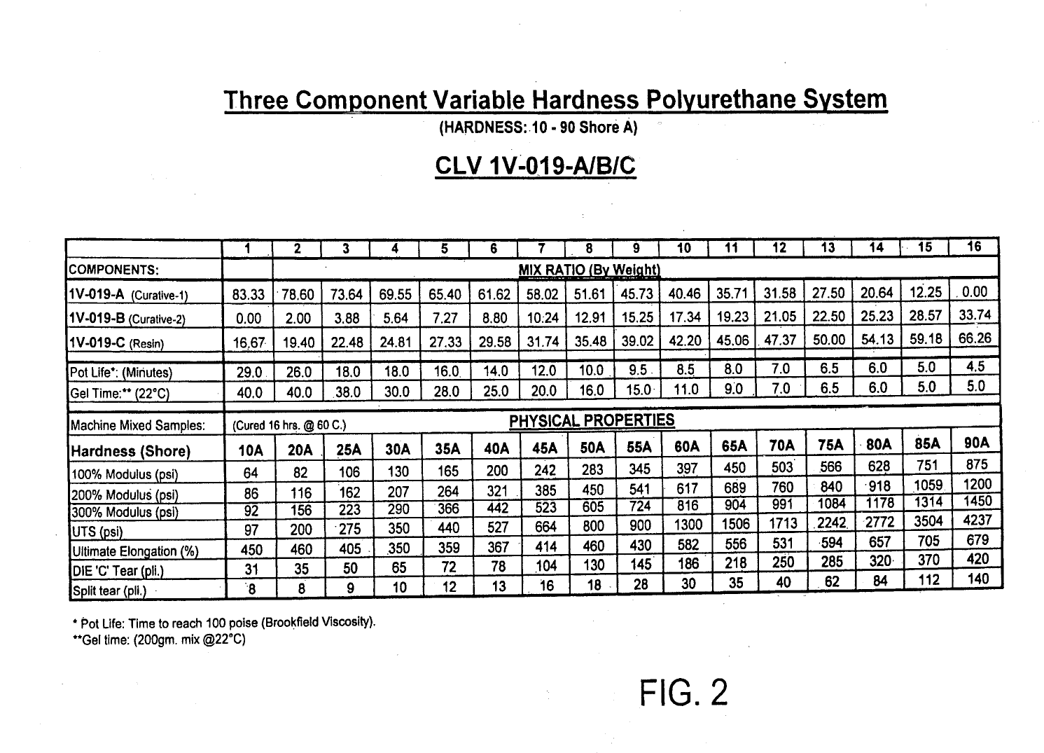

As can be seen from FIGS. 1 and 2, the relative percentages of the two curative components are selected to create a polyurethane compound having a desired hardness. The amount of isocyanate added as a hardener is determined stoichiometrically, based on the molecular weights and proportions of the curative components. A harder polyurethane requires a tighter crosslink chemistry, and therefore smaller molecules, so as the hardness of the polyurethane compound increases more isocyanate is required in the composition to maintain the stoichiometric relation between the hardener and the curative components. The percentage of each curative component can be selected from a chart generated by experimentation, for example as illustrated in FIG. 2 in the case of the specific components used in the preferred embodiment of the invention.

Moreover, in the system and method of the invention the relationship between the proportions of the two curative components and the hardness of the resulting composition is relatively linear, so interpolation between incremental mixture ratios will achieve roughly the desired intermediate hardness. For example, to create a polyurethane compound having a hardness of 67.5 Shore A, and intermediate amount of curative components and isocyanate between the percentages shown in columns 11 and 12 of FIG. 2 would be mixed to yield a compound having a hardness very close to the desired result. With some experimentation a precise hardness can be achieved.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A method of creating a plurality of polyurethane compounds, wherein each polyurethane compound having a predetermined hardness within a range of possible hardnesses from Shore 10 A to Shore 90 A, said method consisting of:
selecting the predetermined hardness of Shore 10 A to Shore 90 A for the polyurethane compound;
selecting a first curative component comprising a first polyol, the first curative component having a hardness of Shore 10 A when mixed alone with an isocyanate;
selecting a second curative component comprising a second polyol, the second curative component having a hardness of Shore 90 A when mixed alone with the isocyanate; and
mixing the first and the second curative components together in a predetermined stoichiometric ratio with the isocyanate to create the polyurethane compound having the predetermined hardness in the range of Shore 10 A to Shore 90 A.

2. The method of claim 1, wherein the isocyanate is methylene diphenyl diisocyanate.

3. The method of claim 1, wherein the first curative component comprises a non reactive plasticizer, a urethane catalyst, and a surfactant.

4. The method of claim 1, wherein the second curative component comprises a liquid aromatic diamine, a urethane catalyst, and a surfactant.

5. The method of claim 1, wherein the polyurethane compound has a pot life of 4.5 minutes to 29.0 minutes.

6. The method of claim 1, wherein said mixing includes a gel time at 22° C. of the polyurethane compound of 5.0 minutes to 40.0 minutes.

7. A method of creating a polyurethane compound having a predetermined hardness in the range of Shore 10A to Shore 90A, said method consisting of:
selecting the predetermined hardness for the polyurethane compound;
selecting a concentration of a first curative component comprising a first polyol by reference to FIG. 1, wherein the first curative component provides a hardness of Shore 10 A when mixed alone with an isocyanate, and wherein the concentration of the first curative component is sufficient to provide the selected hardness of the polyurethane compound;
selecting a concentration of a second curative component comprising a first polyol by reference to FIG. 1, wherein the second curative component provides a hardness of Shore 90 A when mixed alone with an isocyanate, wherein the concentration of the second curative component is sufficient to provide the selected hardness of the polyurethane compound, and wherein the concentrations of the first and second curative components is 100%;
selecting an amount of an isocyanate based on the concentrations of the first and the second curative components, wherein the concentration of the isocyanate is sufficient to provide the selected hardness of the polyurethane compound; and
mixing the first and the second curative components together with the amount of the isocyanate to create the polyurethane compound having the predetermined hardness in the range of Shore 10 A to Shore 90 A.

8. The method of claim 7, wherein the isocyanate is methylene diphenyl diisocyanate.

9. The method of claim 7, wherein the first curative component comprises a non reactive plasticizer, a urethane catalyst, and a surfactant.

10. The method of claim 7, wherein the second curative component comprises a liquid aromatic diamine, a urethane catalyst, and a surfactant.

11. The method of claim 7, wherein the polyurethane compound has a pot life of 4.5 minutes to 29.0 minutes.

12. The method of claim 7, wherein said mixing includes a gel time at 22° C. of the polyurethane compound of 5.0 minutes to 40.0 minutes.

13. A method of creating a polyurethane compound having a predetermined hardness in the range of Shore 10 A to Shore 90 A, said method consisting of:
selecting the predetermined hardness for the polyurethane compound;
selecting a concentration of a first curative component comprising a first polyol by reference to FIG. 2, wherein the first curative component provides a hardness of Shore 10 A when mixed alone with an isocyanate, and wherein the concentration of the first curative component is sufficient to provide the selected hardness of the polyurethane compound;
selecting a concentration of a second curative component comprising a first polyol by reference to FIG. 2, wherein the second curative component provides a hardness of Shore 90 A when mixed alone with an isocyanate, wherein the concentration of the second curative component is sufficient to provide the selected hardness of the polyurethane compound, and wherein the concentrations of the first and second curative components is 100%;
selecting an amount of an isocyanate based on the concentrations of the first and the second curative components, wherein the concentration of the isocyanate is sufficient to provide the selected hardness of the polyurethane compound; and
mixing the first and the second curative components together with the amount of the isocyanate to create the polyurethane compound having the predetermined hardness in the range of Shore 10 A to Shore 90 A.

14. The method of claim 13, wherein the isocyanate is methylene diphenyl diisocyanate.

15. The method of claim 13, wherein the first curative component comprises a non reactive plasticizer, a urethane catalyst, and a surfactant.

16. The method of claim 13, wherein the second curative component comprises a liquid aromatic diamine, a urethane catalyst, and a surfactant.

17. The method of claim 13, wherein the polyurethane compound has a pot life of 4.5 minutes to 29.0 minutes.

18. The method of claim 13, wherein said mixing includes a gel time at 22° C. of the polyurethane compound of 5.0 minutes to 40.0 minutes.
